(19) United States
(12) Patent Application Publication
(10) Pub. No.: US 2016/0037962 A1
(43) Pub. Date: Feb. 11, 2016

(54) Scoop Counting Kitchen Appliance and Related Method

(71) Applicant: Hamilton Beach Brands, Inc., Glen Allen, VA (US)

(72) Inventors: Paula Pennington, Mechanicsville, VA (US); Seth Lichtman, Glen Allen, VA (US); Atle Larsen, Henrico, VA (US); Ray Jia, Shenzhen (CN)

(21) Appl. No.: 14/453,738

(22) Filed: Aug. 7, 2014

(51) Int. Cl. A47J 31/46

(52) U.S. Cl. CPC A47J 31/465; A47J 31/46

(57) ABSTRACT

A hot beverage maker includes a hot liquid generator for receiving a liquid, including at least one heating element for heating the liquid, and a reservoir for receiving an amount of foodstuff. The reservoir is in fluid communication with the hot liquid generator for receiving the hot liquid and making the hot beverage. The reservoir has an outlet for dispensing the hot beverage. The hot beverage maker further includes a sensor for sensing weight of the foodstuff in the reservoir and for generating and outputting electrical signals proportional to the weight of the foodstuff, and a controller for receiving the electrical signals from the sensor and determining a number of scoops of foodstuff present in the reservoir according to the sensed weight of the foodstuff.

### BACKGROUND OF THE DISCLOSURE

The present disclosure is generally directed to a kitchen appliance for preparing a beverage from foodstuff, and, more particularly, to a kitchen appliance for preparing a hot beverage capable of determining and displaying a measurement of the foodstuff placed in the appliance, such as the number of scoops of foodstuff inserted in the appliance.

Kitchen appliances for preparing a beverage are well known. One example of such a kitchen appliance is a coffee maker, which prepares coffee from coffee grounds. Some coffee maker consumers prefer to prepare the coffee maker, i.e., insert the coffee grounds and water into the coffee maker late at night such that the coffee maker solely needs to be powered on the following morning to brew the coffee. Alternatively, other consumers prefer to both prepare and power on the coffee maker early in the morning or at the time they desire coffee. Whether preparing the coffee maker in the morning, evening, or any time of day, consumers may be preparing the coffee maker to brew coffee for several individuals, e.g., multiple family members or guests.

Often, due to distraction or any other reason, and especially when preparing many cups of coffee, consumers forget, miscount, or lose count of the number of coffee scoops that have been inserted into the coffee maker. One disadvantage of conventional coffee makers, as well as other kitchen appliances used to prepare a beverage from foodstuff, is that once the consumer no longer knows the number of scoops inserted into the appliance, the consumer generally must empty the appliance of the inserted, unknown quantity of foodstuff, and begin inserting foodstuff again. Otherwise, they proceed at the risk of making coffee that is not suitable to their or other's tastes. Such a process is tedious, time-consuming, and generally frustrating to the consumer.

Therefore, it would be advantageous to have a kitchen appliance for preparing a beverage from foodstuff, capable of determining and displaying the number of scoops of foodstuff that have been inserted therein. Accordingly, whenever a consumer forgets, miscounts, or loses count of the number of scoops of foodstuff in the appliance, a display on the kitchen appliance notifies them, eliminating the need to keep count or empty the appliance and restart the filling process.

### BRIEF SUMMARY OF THE DISCLOSURE

Briefly stated, one aspect of the present disclosure is directed to a hot beverage maker. The hot beverage maker comprises a hot liquid generator for receiving a liquid, including at least one heating element for heating the liquid, and a reservoir for receiving an amount of foodstuff. The reservoir is in fluid communication with the hot liquid generator for receiving the hot liquid generated thereby. The hot liquid is infused by the foodstuff thereby generating a hot beverage. The reservoir has an outlet for dispensing the hot beverage. The hot beverage maker further includes a sensor for sensing the weight of the foodstuff in the reservoir and for generating and outputting electrical signals proportional to the weight of the foodstuff, and a controller for receiving the electrical signals from the sensor and determining a measurement of the foodstuff placed in the appliance, such as the number of scoops of foodstuff present in the reservoir according to the sensed weight of the foodstuff.

Another aspect of the present disclosure is directed to a method of operating a hot beverage maker. The hot beverage maker includes a hot liquid generator for receiving a liquid, including at least one heating element for heating the liquid, and reservoir for receiving an amount of foodstuff. The reservoir is in fluid communication with the hot liquid generator for receiving the hot liquid and making the hot beverage. The reservoir has an outlet for dispensing the hot beverage. The hot beverage maker includes a sensor for sensing weight of the foodstuff in the reservoir and generating and outputting electrical signals proportional to the weight of the foodstuff, and a controller for receiving the electrical signals from the sensor and determining a number of scoops of foodstuff present in the reservoir according to the sensed weight of the foodstuff. The method of operating the hot beverage maker comprises the steps of: (a) inserting foodstuff into the reservoir, (b) calculating, using the controller, a number of scoops of foodstuff in the reservoir, and (c) repeating steps (a) and (b) until a desired number of scoops are present in the reservoir.

### BRIEF DESCRIPTION OF THE DRAWINGS

The foregoing summary, as well as the following detailed description of the disclosure, will be better understood when read in conjunction with the appended drawings. For the purpose of illustrating the disclosure, there is shown in the drawings an embodiment of a kitchen appliance which is presently preferred. It should be understood, however, that the disclosure is not limited to the precise arrangements and instrumentalities shown. In the drawings:

FIG. 1 is a perspective view of a kitchen appliance according to a preferred embodiment of the disclosure;

FIG. 2 is an enlarged front elevational view of a control panel of the kitchen appliance of FIG. 1;

FIG. 3 is a schematic diagram of certain components of the kitchen appliance of FIG. 1;

FIG. 4 is a top plan view of the kitchen appliance of FIG. 1 with a removed cover;

FIG. 5 is a cross-sectional side elevational view of an upper portion of the kitchen appliance of FIG. 1, taken along taken along the sectional line 5-5 of FIG. 1;

FIG. 6 is an exploded perspective view of a weighing platform and a basket of a reservoir of the kitchen appliance of FIG. 1; showing the weighing platform attached to a sensor;

FIG. 7 is a schematic block diagram of the interrelation between the operative and electronic components of the kitchen appliance of FIG. 1; and

FIG. 8 is a flow diagram depicting the steps of the operation of the kitchen appliance of FIG. 1.

### DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the kitchen appliance, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

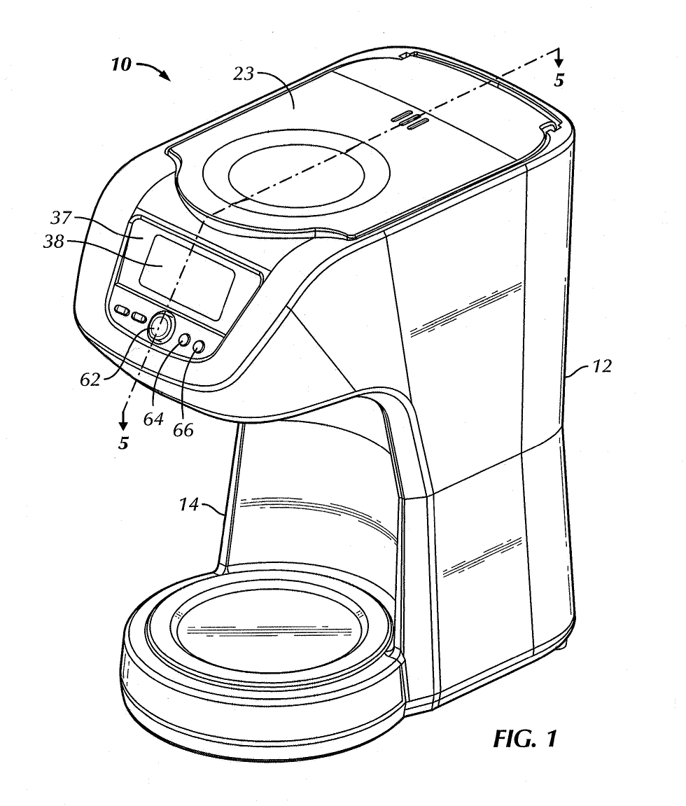

Referring to the drawings in detail, wherein like numerals indicate like elements throughout, FIGS. 1-8 illustrate a kitchen appliance, generally designated 10, in accordance with a preferred embodiment of the present disclosure. The kitchen appliance 10 is intended or designed for preparing a beverage from foodstuff (none shown) to be consumed by a consumer. The present disclosure is not limited by the type of beverage prepared by the kitchen appliance 10 or of the foodstuff used to prepare the beverage. For example, the term “foodstuff,” as used herein, is sufficiently broad to cover any extractible/infusible substance, such as coffee grounds, tea leaves, hot chocolate powder, soup ingredients, oatmeal and the like. Thus, the kitchen appliance 10 is versatile because it may be used to create and/or prepare any one of a variety of different types of beverages from a variety of different types of foodstuff. More specifically, the kitchen appliance 10 preferably heats a liquid, such as water, to a sufficient temperature to be combined with or poured over the foodstuff to create a hot beverage.

As shown in FIG. 1, the kitchen appliance 10 includes an outer housing 12 for enclosing and protecting the internal components of the kitchen appliance 10, as described in detail below. The housing 12 and/or any components thereof may be constructed from any polymer, metal or other suitable material or combinations of materials. For example, an injection molded acrylonitrile butadiene styrene (ABS) material could be employed, but the housing may be constructed of nearly any generally rigid material, such as stainless steel, that is able to take on the general shape of the housing 12 and perform the functionality of the housing 12 described herein. The housing 12 may be generally, completely or partially opaque, translucent or transparent.

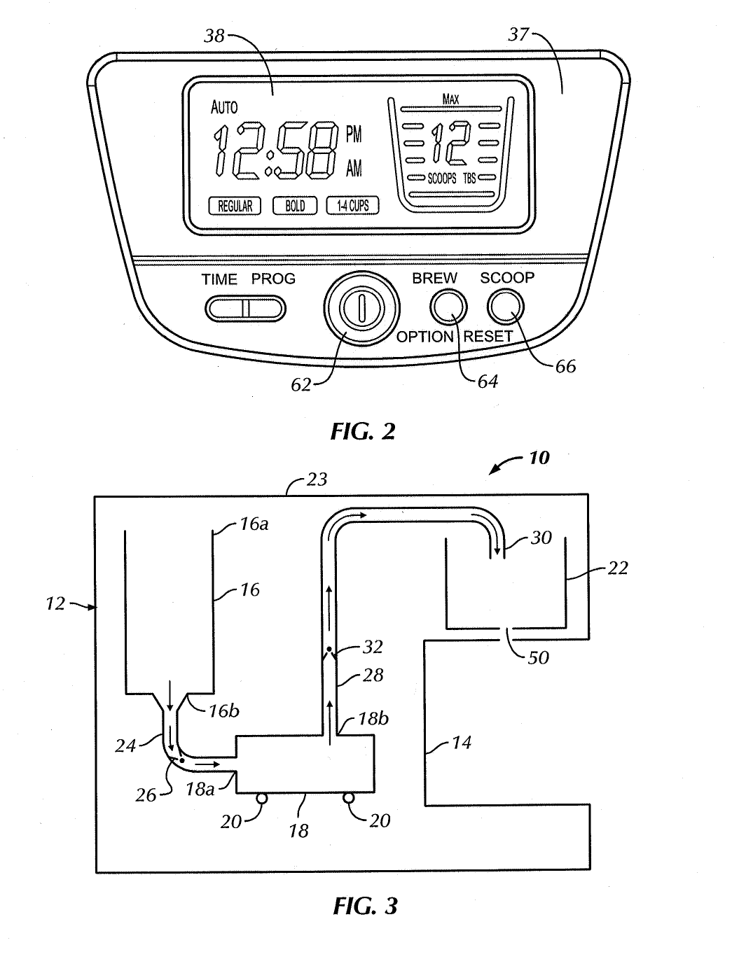

The housing 12 includes a recess 14 (FIG. 1) that is sized, shaped and/or configured to receive and/or support at least a portion of cup, travel mug, pot, carafe, or other vessel (not shown) for receiving a beverage or liquid that is dispensed from the kitchen appliance 10. The vessel will be referred to as a carafe hereinafter. The beverage flows, drips or otherwise accumulates in the carafe, which is subsequently removed from the recess 14 by the consumer prior to consumption of the beverage. As shown best in FIG. 2, the housing 12 also includes a control panel 37 having a display 38 and command buttons. For example, the control panel 37 includes at least an on/off button 62, a brew button 64, i.e., to start a beverage making cycle, and a reset button 66, as will be described further below. The display 38 is preferably a liquid crystal display (LCD) capable of displaying at least the weight of the foodstuff (not shown), or a number of scoops of foodstuff (FIG. 2), present in the kitchen appliance 10, as will be described further below. As should be understood, however, the display 38 is capable of displaying other features, such as, for example, without limitation, the time, strength of the beverage, or number of cups of the beverage being made.

As shown schematically in FIG. 3, the housing 12 includes a cavity 16, for receiving a supply of a fresh liquid, e.g., water, a hot liquid generator 18, including at least one heating element 20 for heating the liquid received from the cavity 16, and a reservoir 22 for receiving an amount of foodstuff and for thereafter receiving a flow of the hot liquid from the hot liquid generator 18. Generally the hot liquid generator 18 and the at least one heating element 20 are located at a lower end of the housing 12, and the reservoir 22 is located at an upper end of the housing 12. Referring again to FIG. 1, a cover 23 is pivotably attached, e.g., via a hinged connection, such as a living hinge, to an upper end of the housing 12. The cover 23 is pivotable about the hinge connection between a first, generally angled, open or upward position (not shown) for providing access to the cavity 16 and the reservoir 22, for liquid and/or foodstuff to be inserted therein, respectively, and a second, closed or downward position (FIG. 1) for closing and/or sealing the cavity 16 and the reservoir 22. However, as should be understood by those of ordinary skill in the art, the cover 23 may be entirely removable from the housing 12 to access the cavity 16 and reservoir 22, and re-engageable to cover or close the cavity 16 and the reservoir 22.

The cavity 16 is preferably sized, shaped and/or configured to receive at least an amount of liquid that is suitable for preparing multiple cups of the beverage, e.g., preferably between about two to eight or even twelve cups. As shown in FIG. 3, the cavity 16 is in fluid connection, at an outlet 16b thereof, with an inlet 18a of the hot liquid generator 18 for receiving liquid therefrom, via a tube 24. The phrase “fluidly connected” is broadly used herein as being in direct or indirect fluid communication. The tube 24 preferably includes a one-way check valve 26 positioned between the cavity 16 and the hot liquid generator 18 to prevent liquid backflow from the hot liquid generator 18 toward the cavity 16. The check valve 26 and any other check valves described herein may be any type of one-way valve, such as a silicone flapper, a ball-type valve, a diaphragm-type valve, a duckbill valve, an in-line valve, a stop-check valve, a lift-check valve, or the like.

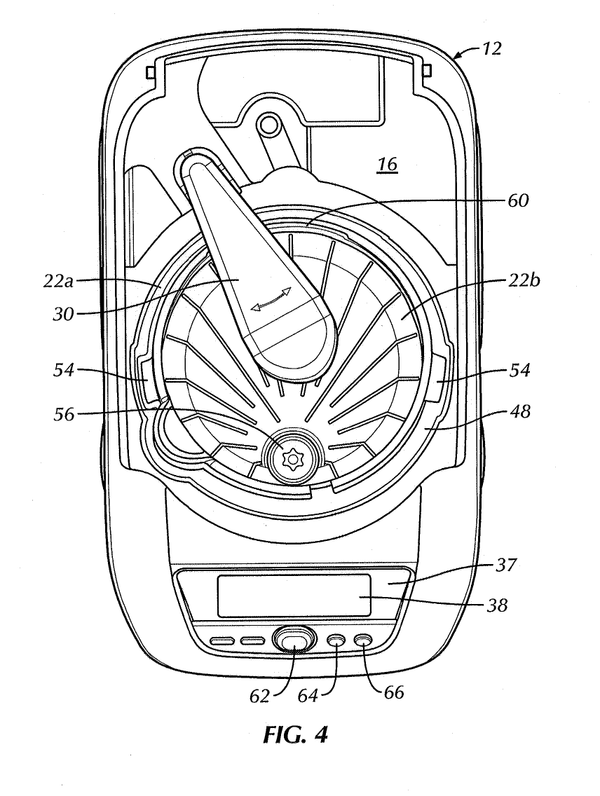

The hot liquid generator 18 can be any mechanism capable of heating a fluid such as a generally U-shaped (in side view), tubular, aluminum extrusion, boiler, spiral heater, or the like. The at least one heating element 20 is in thermal communication with liquid in the hot liquid generator 18. The heating element 20 can be, for example, without limitation, a cal-rod or other resistive heating element. Such a heating mechanism is a generally inexpensive means for heating and motivating liquid in a non-mechanical manner (i.e., no impellers, air pump, or the like), as described further below. Alternatively, the hot liquid may be moved through the kitchen appliance 10 via a pump (not shown), such as, for example, a positive displacement pump, a water pump or an air pump. Likewise, the heating element 20 may alternatively be any of numerous different heating elements, currently known or that later become known and capable of performing the function of the heating element 20 as described herein. The heating element 20 is preferably located outside of, and in contact with, the hot liquid generator 18 to heat the liquid therein. However, the heating element 20 may alternatively be located inside the hot liquid generator 18, in direct physical contact with the liquid. An outlet 18b of the hot liquid generator 18 is connected in fluid communication with the reservoir 22 via a generally upwardly extending riser tube 28. As shown in FIG. 3, the riser tube 28 includes a showerhead 30 (FIG. 4) at a downstream end thereof, located over an open upper end of the reservoir 22. The showerhead 30 is adapted to substantially evenly distribute hot liquid into the reservoir 22, in a manner well known in the art. Similarly to the tube 24, the riser tube 28 preferably includes a one-way check valve 32 positioned between the hot liquid generator 18 and the reservoir 22, for preventing backflow of hot liquid toward the hot liquid generator 18.

As should be understood by those of ordinary skill in the art, the hot liquid generator 18 and the heating element 20 are preferably capable of heating liquid therein to at least a temperature sufficient to create a phase change of at least some of the liquid into gas. Such a phase change creates or generates the force(s) necessary to move fluid throughout the kitchen appliance 10 to make the beverage. Accordingly, when liquid is poured into or is present in the cavity 16 and the heating element 20 is not activated or energized (e.g., pulsed), liquid travels into the hot liquid generator 18 and at least partially into the riser tube 28 until an equilibrium level of the liquid is achieved. In other words, the height of liquid proximate the inlet 18a of the hot liquid generator 18 is generally equal to the height of liquid proximate the outlet 18b of the hot liquid generator 18.

The hot liquid generator 18 can be a gravity-fed device, in which liquid enters therein due to the force of gravity. Thus, at least a portion of the cavity 16 is preferably positioned at a level or height that is higher than the hot liquid generator 18 to provide positive head pressure to fill the hot liquid generator 18 with liquid from the cavity 16. A level or height of a top of the cavity 16 could be lower than a level or height of an entry point to the showerhead 30 so that liquid does not flow into the showerhead 30 prior to activation of the heating element 20.

Once at equilibrium in the kitchen appliance 10, fluid motivation during a brew or heat cycle occurs solely due to a phase change of the fluid that occurs in the hot liquid generator 18 during operation. Shortly after the heating element 20 is activated or energized, a temperature of at least the liquid in the hot liquid generator 18 begins to rise. Eventually, the liquid begins to boil and experiences or exhibits a phase change from liquid to gas, which increases pressure within the hot liquid generator 18. Pressure created from the gas attempts to push liquid out of the hot liquid generator 18. Due to the check valve 26 preventing liquid within the hot liquid generator 18 from entering the cavity 16, the riser tube 28 offers the least resistance to the rising liquid. Therefore, the pressure pushes at least some liquid out of the hot liquid generator 18 through the outlet 18a, upwardly through the riser tube 28, out through the showerhead 30 and into the reservoir 22. The check valve 32 in the riser tube 28 prevents the liquid therein from flowing back into hot liquid generator 18. Activation or pulsing of the heating element 20 continues and/or repeats until all or substantially all of the liquid in the system is displaced from the cavity 16 to the reservoir 22.

The specific brewing mechanism can vary as would be understood by one of ordinary skill in the art. Therefore, as discussed previously, the hot water generator can be a boiler that is fed by a pump or any number of variations in the mechanism by which the beverage maker delivers hot fluid to a foodstuff in the reservoir 22.

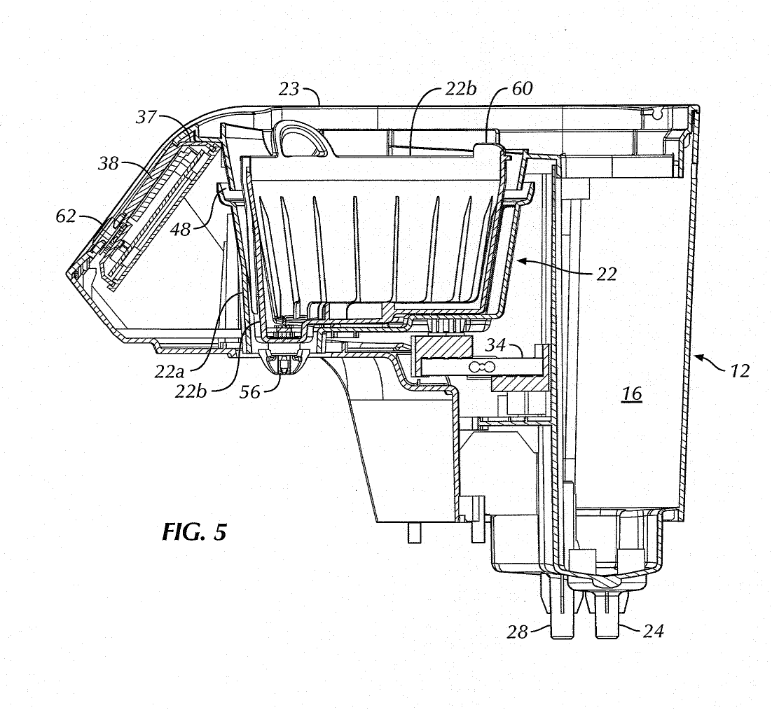

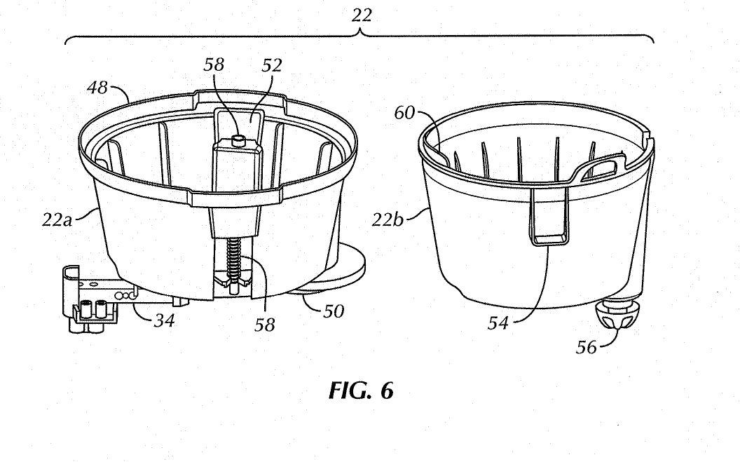

Referring now to FIGS. 5 and 6, the reservoir 22 includes a weighing platform 22a and a basket 22b for receiving the foodstuff therein, removably received (FIG. 5) in the weighing platform 22a. The weighing platform 22a includes an open upper end 48 for receiving the basket 22b therethrough and an outlet 50 at the opposing bottom end of the platform 22a. As shown best in FIG. 6, the weighing platform 22a includes at least one slot 52 (two slots 52 in the illustrated embodiment) for aligning the basket 22b in the appropriate position when inserted in the weighing platform 22a. The basket 22b includes complimentary tab(s) 54, for mating with the slot(s) 52 of the weighing platform 22a, for proper insertion into the weighing platform 22a.

When properly inserted in the weighing platform 22a, a dispensing valve 56 of the basket 22a projects through the outlet 50 of the weighing platform 22a. The dispensing valve 56 operates as an automatic pause and serve feature of the kitchen appliance 10, in a manner well known in the art. That is, as should be understood by those of ordinary skill in the art, the valve 56 is spring loaded into a normally closed position (FIG. 6). Any liquid accumulated in the basket 22b, via the showerhead 30, is not dispensed therefrom when the valve 56 is in the normally closed position. During operation of the kitchen appliance 10, when a carafe (not shown) is placed into the recess 14, a cover of the carafe biases the dispensing valve 56 into an upward, open position (not shown), thereby allowing liquid accumulating in the basket 22a to be dispensed through the open dispensing valve 56 and into the carafe. If the carafe is removed from the recess 14 at any point, the spring loaded dispensing valve 56 is biased back into the normally closed position, thereby preventing dripping of the hot beverage into the recess 14 without the presence of a carafe therein.

Each slot 52 of the weighing platform 22a includes a spring loaded support 58, biased to support the basket 22b when inserted into the weighing platform 22a to a relatively upward position such that the dispensing valve 56 does not contact a carafe in the recess 14, as will be explained further below, and thus the dispensing valve 56 remains in the normally closed position. As shown in FIGS. 5 and 6, the basket 22b further includes a ramp 60 along a portion of the upper rim thereof. As shown in FIG. 4, the showerhead 30 also operates as a lever rotatable about the axial axis thereof, i.e., swivelable, between an operating position (FIG. 4), in which the showerhead 30 engages the ramp 60 and overlies the open upper end 48 of the reservoir 22, and a non-operating position (not shown), in which the showerhead 30 is not engaged with the ramp 60, and generally does not overlie the reservoir 22, but rather generally overlies the cavity 16. As the showerhead 30 swivels clockwise toward the operating position, the ramp 60 interferes therewith. As the showerhead 30 slides along the ramp 60, the showerhead 30 depresses the ramp 60, and thus depresses the entire basket 22b, against the bias of the spring loaded support 58, into a relatively downward position wherein the dispensing valve 56 contacts and is opened by the carafe in the recess 14. As should be understood by those of ordinary skill in the art, however, a separate lever may be utilized, independent of the showerhead 30, to perform the above-mentioned function of the showerhead 30.

Referring now to FIG. 5, the kitchen appliance 10 further includes a sensor 34 for measuring the weight of the foodstuff in the basket 22b of the reservoir. In the illustrated embodiment, the sensor 34 is a load cell, and, preferably, a bending beam load cell. For simplicity, the sensor 34 will be referred to hereinafter as the load cell 34. However, as should be understood by those of ordinary skill in the art, the sensor 34 may be any type of sensor, currently known or that becomes known, and which is capable of performing the functions of the load cell 34 described herein. As shown in FIG. 5, the load cell 34 is supported at one end by a side wall of the cavity 16, and projects therefrom as a cantilever beam. However, as should be understood, the load cell 34 may alternatively be supported by another structure within the housing 12. The load cell 34 supports the weighing platform 22a thereon (and the basket 22b within the weighing platform) at an opposing end. As shown in FIG. 5, the weighing platform 22a is vertically supported solely by the load cell 34.

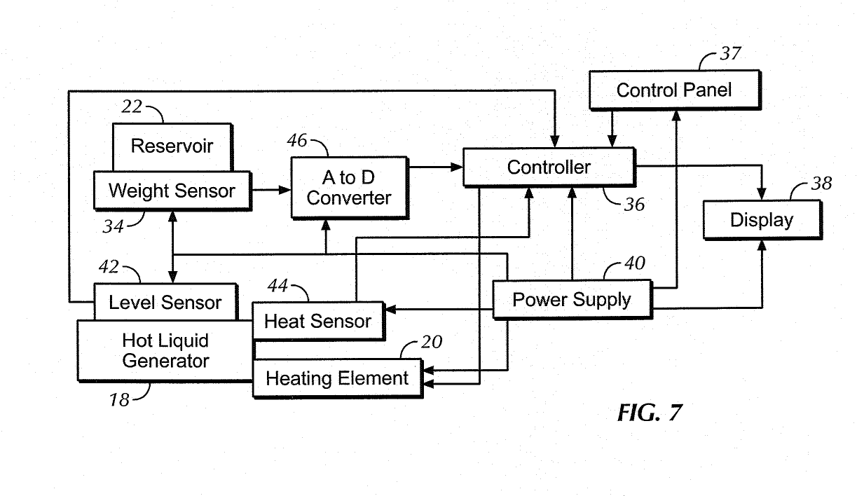

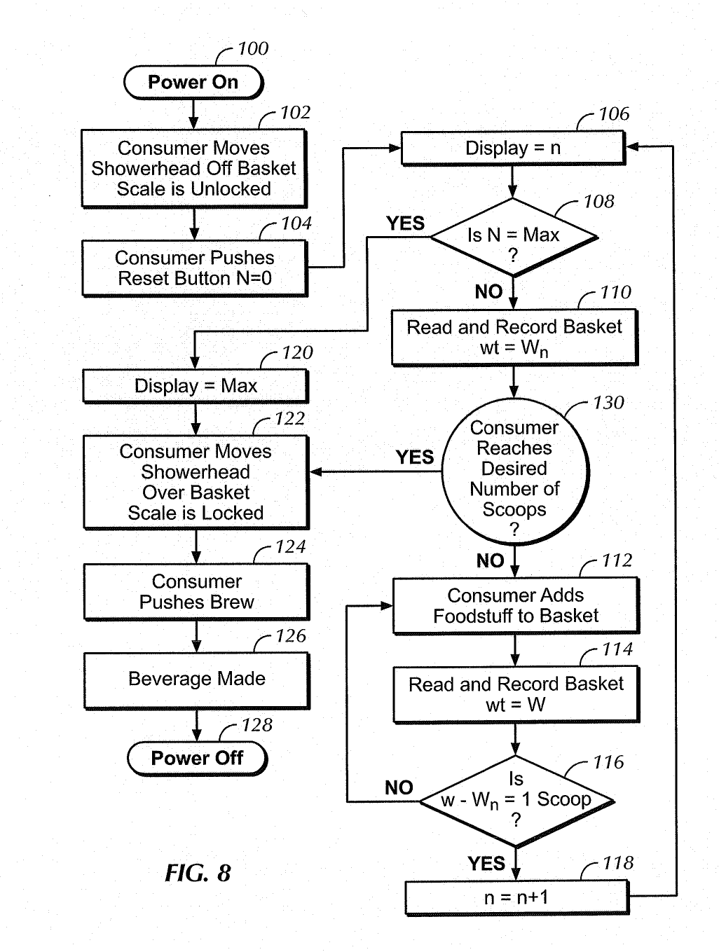

FIG. 7 is a schematic block diagram of the interrelation between the operative and electronic components of the kitchen appliance 10. As shown, the kitchen appliance 10 further includes a controller 36. The controller 36 preferably includes or is operatively coupled to a memory (not shown) that stores the software code described below and any additional code or software for controlling the operation of the kitchen appliance 10. The memory can be any known or suitable memory device such as random access memory (RAM), read only memory (ROM), flash RAM, hard disk, or the like. The controller 36 may also include, as hardware or software, or may be operatively connected to other components, such as clocks, timers, or the like (not shown) needed for controlling the operation of the kitchen appliance 10. In a preferred embodiment, the controller 36 comprises a microprocessor. Accordingly, the controller 36 will be referred to hereinafter as the microprocessor 36. However, as should be understood by those of ordinary skill in the art, the controller 36 may be any type of controller, currently known or that later becomes known, capable of performing the functions of the microprocessor 36 described herein.

As shown schematically in FIG. 7, a power supply 40 powers the operative components of the kitchen appliance 10, including the control panel 37, display 38, microprocessor 36, heating element 20, a heat sensor 44, a level sensor 42, load cell (or weight sensor) 34, and an analog to digital converter 46. As should be understood, the power supply 40 preferably includes a power cord 40 connectable to a 120V wall outlet. However, alternative forms of power supplies may be utilized. As shown, the microprocessor 36 receives commands from the control panel 38. Input commands from the control panel 37 to the microprocessor include power on/off 62, start brew or heat cycle 64, or reset measurements 66 as will be discussed further below.

Generally, the microprocessor 36 periodically receives, e.g., once every five or ten milliseconds, data from the level sensor 42 (known in the art and operatively connected to the hot liquid generator 18 in a manner well known in the art), correlating to a level of the liquid present in the hot liquid generator 18 to determine whether sufficient liquid is present therein. If the microprocessor 36 determines that the level of liquid in the hot liquid generator 18 is sufficient, the microprocessor 36 activates the heating element 20 to heat the liquid. The microprocessor 36 also periodically receives, e.g., once every five or ten milliseconds, data from a heat sensor 44 (known in the art and operatively connected to the hot liquid generator 18 in a manner well known in the art), correlating to the temperature of the liquid present in the hot liquid generator 18, to detect whether the liquid has reached a sufficient temperature. Typically, the microprocessor 36 activates the heating element 20 until the liquid within the hot liquid generator 18 is at or near the boiling point temperature thereof to create a phase change of at least some of the liquid into gas. As should be understood, the lever sensor 42 and the heat sensor 44 generally include integrated analog to digital converters. Thus, measured analog signals are converted to digital signals prior to transmission to the microprocessor 36. Alternatively, measured analog signals by the lever sensor 42 and/or the heat sensor 44 may be communicated to external analog to digital converters prior to communication to the microprocessor 36.

The microprocessor 36 also receives signals from the load cell 34. Namely, the reservoir 22, supported in the housing 12 solely by the load cell 34, applies an unquantified amount of force onto the load cell 34. The load cell 34 converts the unquantified amount of force into electrical signals in a manner well known in the art. That is, strain on the load cell 34 is measured by strain gauges therein according to the deflection of the load cell 34 caused by the weight of the reservoir 22, and converted into electrical signals, e.g., millivolts. The load cell 34 periodically transmits the electrical signals to the microprocessor 36. An analog to digital converter 46 converts the analog electrical signals into digital signals for use by the microprocessor 36.

The microprocessor 36 scales the data received from the load cell 34, in a manner known in the art, to quantify the force applied by the weighing platform 22a and everything therein onto the load cell 34. As known, force is measured in Newtons, which equals 1 kg·m/s². The microprocessor 36 thereafter calculates the mass, i.e., the weight of the weighing platform 22a and everything therein, according to the formula: mass (kg)=calculated force (kg·m/s²)/acceleration due to gravity (9.8 m/s²). In a preferred embodiment, the microprocessor 36 converts the mass in kilograms to grams by multiplying the mass in kilograms by a factor of 10³. Once the mass in grams is determined, the number of scoops of foodstuff in the reservoir 22 can be calculated, as explained further below, and the microprocessor 36 communicates the calculated number of scoops to the display 38 for display.

Referring primarily to the flow diagram of FIG. 8, the major operational steps of the kitchen appliance 10, and thus the microprocessor 36, will now be described. A power on sequence 100 is initiated when the kitchen appliance 10 is plugged into an outlet and a consumer depresses the on/off button 62. At power on 100, a splash screen and/or blinking clock may be provided on the display 38 to indicate the powered-on state of kitchen appliance 10 to the consumer. Afterwards, a consumer generally lifts the cover 23 to access the cavity 16 and the reservoir 22. If the showerhead 30 is in the operating position (FIG. 4), the display 38 does not display any measurements, i.e., the scale is locked. This is because when the showerhead 30 is in the operating position, and therefore depressing the basket 22b, the force ultimately applied to the weighing platform 22a receiving the basket 22b by the showerhead 30 distorts any measurements taken by the load cell 34. Additionally, in the depressed position of the basket 22b, a carafe in the recess 14 biases the dispensing valve 56 into the open position, i.e., lifts the dispensing valve 56, which also distorts any measurements taken by the load cell 34.

At 102 the consumer swivels the showerhead into the non-operating position, i.e., disengaged from the ramp 60 and not overlying the basket 22b, to unlock the scale. Once unlocked, the spring loaded support 58 biases the basket 22b to the relatively upward position. Accordingly, neither the showered head 30 nor the carafe positive influences measurements of the load cell 34. The load cell 34 measures and communicates data to the microprocessor 36 correlating to the weight of the weighing platform 22a itself and the empty basket 22b therein. This is because the weighing platform 22a is supported solely by the load cell 34. Thus, at 104 the consumer presses the reset button 66, instructing the microprocessor 36 to tare the number of scoops N to zero. That is, the microprocessor 36 equates the measured weight of the weighing platform 22a and the empty basket 22b therein with the presence of zero scoops of foodstuff in the basket 22b. Weight is calculated by the microprocessor 36, preferably in grams, based on the periodic electric signals received from the load cell 34 in the manner previously described. At 106, the microprocessor 36 instructs the display 38 to display the number of scoops N. Thus, the first time the display 38 displays the number of scoops N, it will display zero.

At 108, the microprocessor 36 determines whether the number of scoops N equals the maximum number of scoops MAX that the basket 22b is intended to receive. In a preferred embodiment, the intended maximum number of scoops MAX is 16 scoops. However, as should be understood by those of ordinary skill in the art, the maximum number of scoops may be altered (by reprogramming the microprocessor 36), to be more or less. If the microprocessor 36 determines that the number of scoops N is less than the maximum number of scoops, (i.e., NO as shown in FIG. 8), the microprocessor 36 resumes reading the signals periodically communicated from the load cell 34 at 110, and records the calculated weight W_{T} of the basket 22b as initial weight W_{N}.

If the consumer decides that the number of scoops N of foodstuff present in the basket 22a and displayed on the display 38 is the desired number of scoops, the consumer swivels the showerhead 30 back into the operating position at 122, to re-lock the scale. Otherwise, if the consumer desires more scoops of foodstuff, the consumer adds additional amounts of foodstuff to the basket 22b at 112. At 114, the microprocessor 36 continues reading the signals periodically received from the load cell 34 and records the calculated current weight W_{T} of the contents of the basket 22a as weight W.

At 116, the microprocessor 36 determines whether the current weight W minus the initial weight W_{N} is equivalent to one scoop. In a preferred embodiment, one scoop of foodstuff is equivalent to approximately 5 grams of foodstuff. However, as should be understood, one scoop may be equated with more or less foodstuff. Accordingly, the microprocessor 36 only determines that an additional scoop of foodstuff has been added to the basket 22b when the W_{T} minus W_{N} is approximately 5 grams. In a preferred embodiment, the microprocessor 36 only communicates to the display 38 an increase in full scoop increments and the display 38 displays number of scoops N in full scoop increments. Accordingly, in a preferred embodiment, the microprocessor 36 first instructs the display 38 to display that one scoop of foodstuff is present in the basket when approximately a first 2.5 grams of foodstuff are added to the basket 22b. Thus, for example, the microprocessor instructs the display 38 to display 0 scoops up to about 2.5 grams of foodstuff present in the basket 22b. Between about 2.51 grams to about 7.5 grams, the microprocessor instructs the display 38 to display 1 scoop. Between about 7.51 grams to about 12.5 grams, the microprocessor instructs the display 38 to display 2 scoops. However, as should be understood by those of ordinary skill in the art, the microprocessor 36 may alternatively calculate half scoops, or different fractions of a scoop, and instruct the display 38 to display that amount of scoops.

At 118, if the microprocessor 36 determines that the current weight W_{T} minus the previous weight W_{N} is equivalent to one scoop, the microprocessor changes the number of scoops N to N+1. Then at 106, microprocessor instructs the display 38 to display N scoops. Otherwise, if the microprocessor determines that the current weight W_{T} minus the previous weight W_{N} is not equivalent to an additional scoop, the consumer continues to add foodstuff at 112 and steps 112 to 116 are repeated. Steps 106 to 118 can be repeated until at 108, the microprocessor 36 determines that the intended maximum number of scoops MAX is present, or the consumer reaches the desired number of scoops at 130.

If at 108, the microprocessor 36 determines that the intended maximum number of scoops MAX is present, e.g., about 16 scoops, the microprocessor 36 instructs the display 38 to display MAX, e.g., in a flashing manner, at 120. In this instance, or if the consumer otherwise reaches the desired number of scoops before the intended maximum number of scoops is reached at 130, the consumer swivels the showerhead 30 back into the operating position at 122, to re-lock the scale. Swiveling the showerhead 30 back into the operating position also depresses the basket 22b into the relatively depressed position, such that a cover of the carafe contacts and opens the dispensing valve 56. Thereafter, at 124, the consumer pushes the brew button 64, i.e., start making the beverage, and the beverage is made at 126. To make the beverage, the hot liquid reaches the showerhead 30 in the manner previously described, and is dispensed atop the foodstuff in the basket 22b. The hot liquid flows through the foodstuff in the basket 22b, picking up the essence of the foodstuff (i.e., brewing) on the way down into carafe in the recess 14, through the dispensing valve 56. Once the consumer is finished using the kitchen appliance 10, the consumer may press the on/off button 62 to power off the appliance at 128.

It will be appreciated by those skilled in the art that changes could be made to the embodiment described above without departing from the broad inventive concept thereof. For example, a sensor 34 may be similarly used with respect to the cavity 16 to measure the weight of the liquid therein. Likewise, a sensor 34 may be similarly used with respect to the carafe, to measure the weight of the brewed beverage therein. With the data measured by the sensor 34 the controller 36 can provide different forms of feedback to a consumer via the display 38. For example, a light may turn on when a sensor 34 senses that adequate liquid has been inserted in the cavity 16. Alternatively, or additionally a light may turn on when a sensor 34 senses that the weight of the carafe indicates that the brewing cycle has completed. As another option, the kitchen appliance 10 may make a sound, rather than displaying a light. Additionally, all data collected by the controller 36 from the sensor(s) 34 can be utilized to control the brewing process. It is understood, therefore, that this disclosure is not limited to the particular embodiments disclosed, but it is intended to cover modifications within the spirit and scope of the present disclosure as defined by the appended claims.

We claim:

1. A hot beverage maker comprising:
a hot liquid generator for receiving a liquid, including at least one heating element for heating the liquid;
a reservoir for receiving an amount of foodstuff, the reservoir being in fluid communication with the hot liquid generator for receiving the hot liquid and making the hot beverage, and having an outlet for dispensing the hot beverage;
a sensor for sensing weight of the foodstuff in the reservoir and for generating and outputting electrical signals proportional to the weight of the foodstuff; and
a controller for receiving the electrical signals from the sensor and determining a measurement of the foodstuff present in the reservoir according to the sensed weight of the foodstuff.

2. The hot beverage maker of claim 1, wherein the measurement of the foodstuff present in the reservoir comprises the number of scoops of foodstuff present in the reservoir according to the sensed weight of the foodstuff.

3. The hot beverage maker of claim 2, further comprising a display for receiving electrical signals from the controller and displaying the number of scoops determined by the controller.

4. The hot beverage maker of claim 1, wherein the sensor is a load cell.

5. The hot beverage maker of claim 4, wherein the reservoir comprises a weighing platform for receiving the foodstuff thereon, the weighing platform being supported solely by the load cell.

6. The hot beverage maker of claim 5, wherein the reservoir further comprises a basket, received within the weighing platform, for directly receiving the foodstuff.

7. The hot beverage maker of claim 5, wherein the sensor is a bending beam load cell and the weighing platform is supported by a free end of the load cell.

8. The hot beverage maker of claim 1, wherein the controller comprises a microprocessor.

9. The hot beverage maker of claim 2, wherein about five grams of foodstuff corresponds to one scoop.

10. The hot beverage maker of claim 6, the weighing platform further comprising at least one spring loaded support biased to support the basket when the basket is inserted into the weighing platform to a relatively upward position such that a dispensing valve does not contact a carafe located on the hot beverage maker.

11. A method of operating a hot beverage maker having a hot liquid generator for receiving a liquid, including at least one heating element for heating the liquid, a reservoir for receiving an amount of foodstuff, the reservoir being in fluid communication with the hot liquid generator for receiving the hot liquid and making the hot beverage and having an outlet for dispensing the hot beverage, a sensor for sensing weight of the foodstuff in the reservoir and generating and outputting electrical signals proportional to the weight of the foodstuff, and a controller for receiving the electrical signals from the sensor and determine a number of scoops of foodstuff present in the reservoir according to the sensed weight of the foodstuff, the method comprising:
(a) inserting foodstuff into the reservoir;
(b) calculating, using the controller, a number of scoops of foodstuff in the reservoir; and
(c) repeating steps (a) and (b) until a desired number of scoops is present in the reservoir.

12. The method of claim 11, wherein the hot beverage maker further comprises a display, and further comprising the step of the display receiving electrical signals from the controller and displaying the number of scoops determined by the controller.

13. The method of claim 11, further comprising the step of sensing, using the sensor, the weight of the foodstuff in the reservoir, and wherein the calculating step comprises the steps of receiving the signal from the sensor and determining a number of scoops of foodstuff present in the reservoir according to the sensed weight of the foodstuff.

14. The method of claim 13, further comprising the step of biasing the reservoir to a relatively upward position such that a dispensing valve does not contact a carafe.
